(19) United States
(12) Patent Application Publication
(10) Pub. No.: US 2021/0283833 A1
(43) Pub. Date: Sep. 16, 2021

(54) THREE-DIMENSIONAL PRINTING

(71) Applicant: Hewlett-Packard Development Company, L.P., Spring, TX (US)

(72) Inventors: Greg Scott Long, Corvallis, OR (US); Todd A. Berdahl, Corvallis, OR (US); Michael D. Long, Vancouver, WA (US); Brian E. Bolf, Corvallis, OR (US); Ashley Diane Mason, Corvallis, OR (US); Luke Bockman, Vancouver, WA (US)

(21) Appl. No.: 17/256,928

(22) PCT Filed: Oct. 26, 2018
(86) PCT No.: PCT/US2018/057815

§ 371 Date: Dec. 29, 2020

(51) Int. Cl. B29C 64/153; B29C 64/214; B29C 64/218; B29C 64/245; B33Y 10/00; B33Y 30/00; B33Y 70/00

(52) U.S. Cl. CPC B29C 64/153; B29C 64/214; B29C 64/218; B29K 2077/00; B33Y 10/00; B33Y 30/00; B33Y 70/00; B29C 64/245

(57) ABSTRACT

An example build material spreader for a three-dimensional (3D) object printer has a spreader surface to contact a build material and spread the build material in a build material layer by translating the build material spreader through a bed of the build material to shear the build material and form a smooth exposed surface of the build material layer. The spreader surface has a surface energy less than a maximum surface energy.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc., of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light, infrared light, or microwave energy.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram depicting an example of a three-dimensional printing method disclosed herein;

FIGS. 2A through 2F are schematic and partially cross-sectional views depicting the formation of a part layer using an example of a build material spreader in an example of a three-dimensional object printer in an example of a three-dimensional printing method disclosed herein; and

FIG. 3 is a simplified isometric and schematic view of an example of a 3D printing system.

### DETAILED DESCRIPTION

In some examples of three-dimensional (3D) printing, a base layer of build material is deposited on a build platform. A portion of the build material in the base layer is coalesced to form a first layer of a 3D object. Additional layers of the build material are deposited and additional layers of the 3D object are formed, layer-by-layer. After all of the layers of the 3D object have been formed, the 3D object is extracted from the build material that has not coalesced.

In some 3D printing devices disclosed herein, improvements in uniformity in the distribution of the build material in the layers of build material that are ready for coalescing may lead to improvements in the quality of the 3D object. For example, reducing density variation in the distribution of the build material in the layers of build material may reduce color variability and/or strength variability of portions of the 3D object that is formed from the layers.

Build Material Spreader for 3D Object Printer

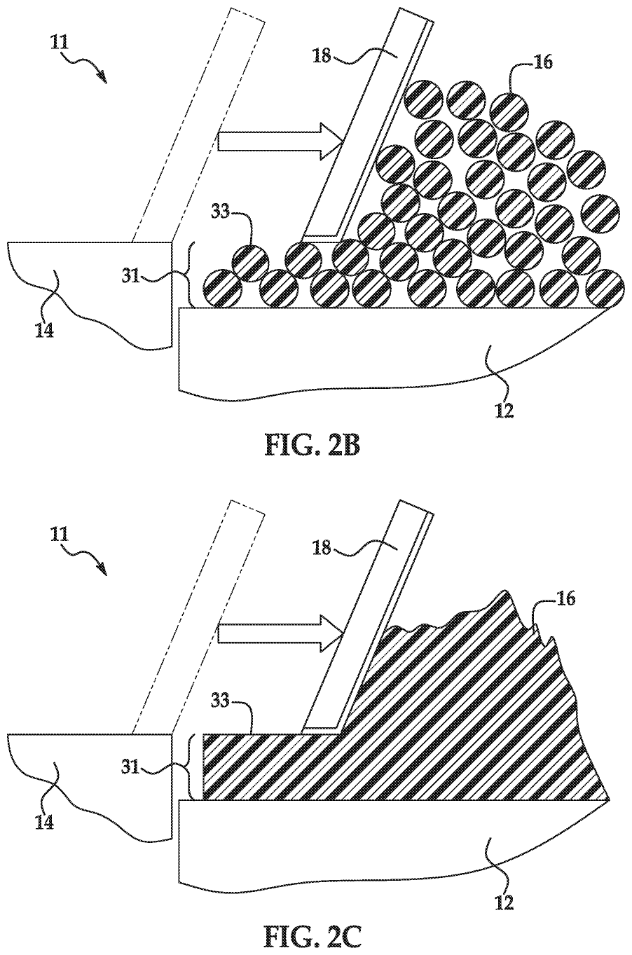

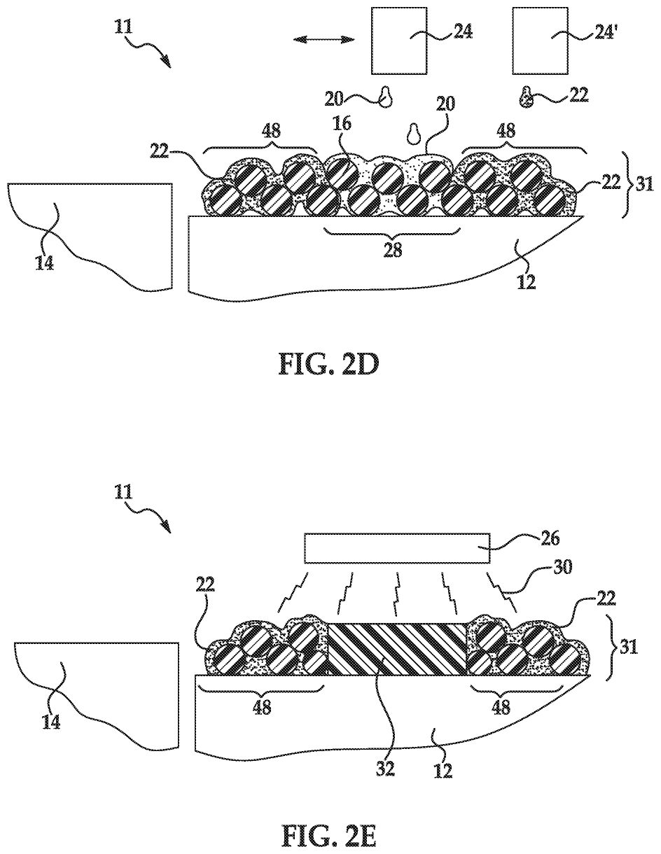

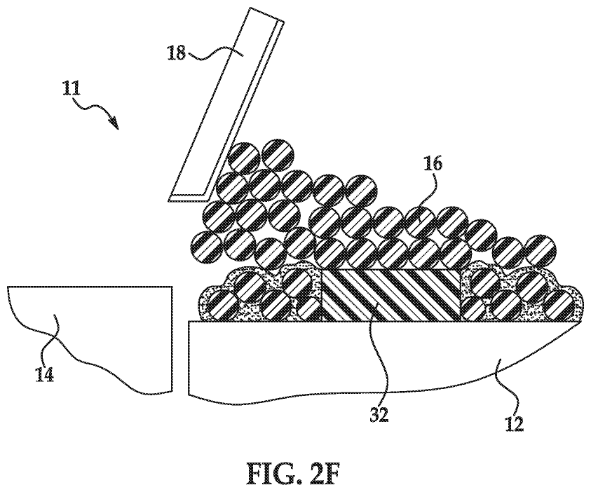

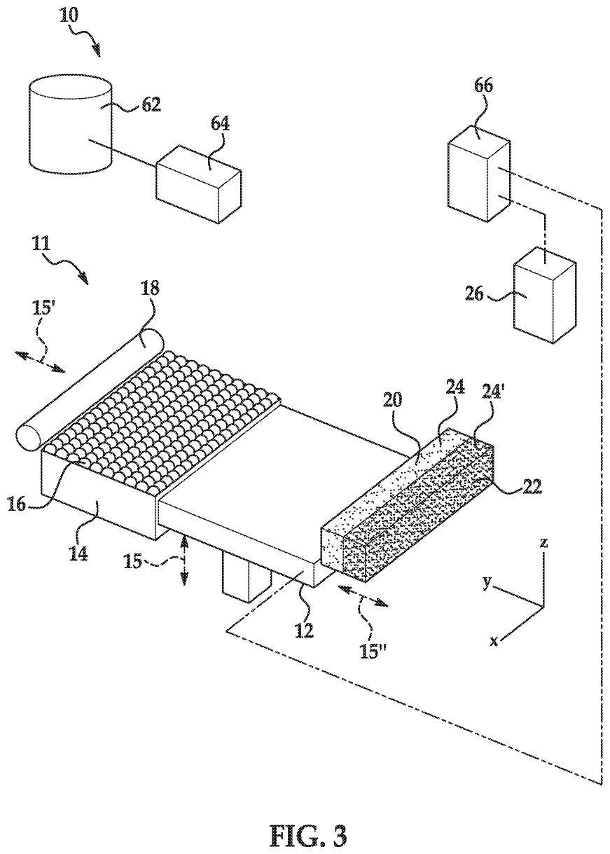

An example of a build material spreader for a 3D object printer disclosed herein is shown in FIGS. 2A, 2B, 2C, and 2F, and in FIG. 3. In examples of the present disclosure, the build material spreader 18 for the 3D object printer includes a spreader surface 50 to contact a build material 16 and spread the build material 16 in a build material layer 31 by translating the build material spreader 18 through a bed 17 of the build material 16 to shear the build material 16 and form a smooth exposed surface 33 of the build material layer 31. The spreader surface 50 has a surface energy less than a maximum surface energy.

It is to be understood that the size of the particles of the build material 16 are exaggerated in FIGS. 2A, 2B, 2D, 2E, 2F, and 3. In some examples, the particle size of the build material 16 ranges from about 50 micrometers (μm) to about 200 μm. The particle size may refer to an average diameter of a particle distribution, such as volume-weighted mean diameter or number-weighted mean diameter. FIG. 2C depicts a smooth exposed surface 33 of the build material layer 31. As used herein, a smooth exposed surface 33 is a surface that is substantially parallel to the build area platform/substrate 12. Roughness of the smooth exposed surface 33 is mainly from granularity of the particles of the build material 16. A smooth exposed surface 33 has less density variation than a rough surface.

The build material spreader 18 shears the build material 16 by pressing against the bed 17 of the build material 16 while moving parallel to the exposed surface 33, somewhat like how a trowel is used to smooth concrete. The build material particles 16 are not normally cut by the shearing action, but rather, are pushed ahead of the build material spreader 18 and over the build material layer 31. Voids in the build material layer 31 are filled-in, and excess build material 16 is pushed aside by the shearing action of the moving build material spreader 18.

The build material spreader 18 may be a blade (e.g., a doctor blade), a roller (see FIG. 3), a combination of a roller and a blade, and/or any other device capable of spreading the polymeric build material 16 over the substrate 12.

In the examples of the build material spreader 18 disclosed herein, the spreader surface 50 has a surface energy that is less than a maximum surface energy, and the maximum surface energy is based on a composition of the build material 16. In other words, the maximum surface energy of the spreader surface 50 that will produce a smooth exposed surface 33 of the build material layer 31 may be different for build materials 16 having different compositions. In some examples, the composition of the build material 16 includes polyamide 12 (PA12) powder, and the maximum surface energy is a Fowkes Surface Free Energy (SFE) of about 19 dynes per centimeter. In these examples, the spreader surface 50 has a surface energy that is less than 19 dynes per centimeter.

In some examples of the present disclosure, the spreader surface 50 has a Root Mean Square (RMS) surface roughness less than about 400 μm.

The build material spreader 18 may be made from a single material that has the desired surface energy, or the build material spreader 18 may have a surface layer 52 disposed on a spreader base 19, where the surface layer 52 has the desired surface energy. The surface layer 52 disposed on the spreader base 19 is depicted in FIG. 2A. In FIG. 2A, the surface layer 52 is depicted as having a thickness 54. The thickness 54 of the surface layer 52 may be any thickness that is in excess of the average peak to valley roughness (i.e., the RMS surface roughness) of the underlying spreader base 19. This results in a spreader surface 50 that is relatively uniform and homogenous. The surface layer 52 may be a thick film, thin film, plate or other layer of material that is adhered to the spreader base 19. In some examples, the spreader surface 50 is a surface layer 52 of polyimide tape (a commercially available example of which is sold under the tradename KAPTON® tape, from Dupont), masking tape, fiberglass tape, flat acrylic enamel paint, or silicon nitride. In some examples, the spreader surface 50 is a surface layer 52 of a TUFRAM® 615 coating material, commercially available from General Magnaplate Corporation.

3D Object Printer

An example of a 3D object printer 11 disclosed herein is shown in FIGS. 2A, 2B, 2C, 2F and FIG. 3. In examples of the present disclosure, the 3D object printer 11 includes a build material spreader 18 having a spreader surface 50 to contact a build material 16 and spread the build material 16 in a build material layer 31 by translating the build material spreader 18 through a bed 17 of the build material 16 to shear the build material 16 and form a smooth exposed surface 33 of the build material layer. The spreader surface 50 has a surface energy less than or equal to a maximum surface energy.

In some examples of the 3D object printer 11 disclosed herein, the maximum surface energy is based on a composition of the build material 16. As stated above, the maximum surface energy that will produce a smooth exposed surface 33 of the build material layer 31 may be different for build materials 16 having different build material compositions. In some examples, the composition of the build material 16 includes polyamide 12 powder, and the maximum surface energy is a Fowkes Surface Free Energy (SFE) of about 19 dynes per centimeter.

In some examples of the 3D object printer 11 disclosed herein, the spreader surface 50 has an RMS surface roughness less than about 400 microns.

As stated above, the build material spreader 18 may be made from a single material, or the build material spreader 18 may have a surface layer 52 disposed on a spreader base 19 as depicted in FIG. 2A. In some examples of the 3D object printer 11 disclosed herein, the spreader surface 50 is a surface layer 52 of polyimide tape, masking tape, fiberglass tape, flat acrylic enamel paint, or silicon nitride. In some examples, the spreader surface 50 is a surface layer 52 of a TUFRAM® 615 coating material.

The 3D object printer 11 includes at least the build material spreader 18. It is to be understood that the 3D object printer 11 may also include additional components, such as those described hereinbelow in reference to the 3D printing system 10.

3D Printing Method

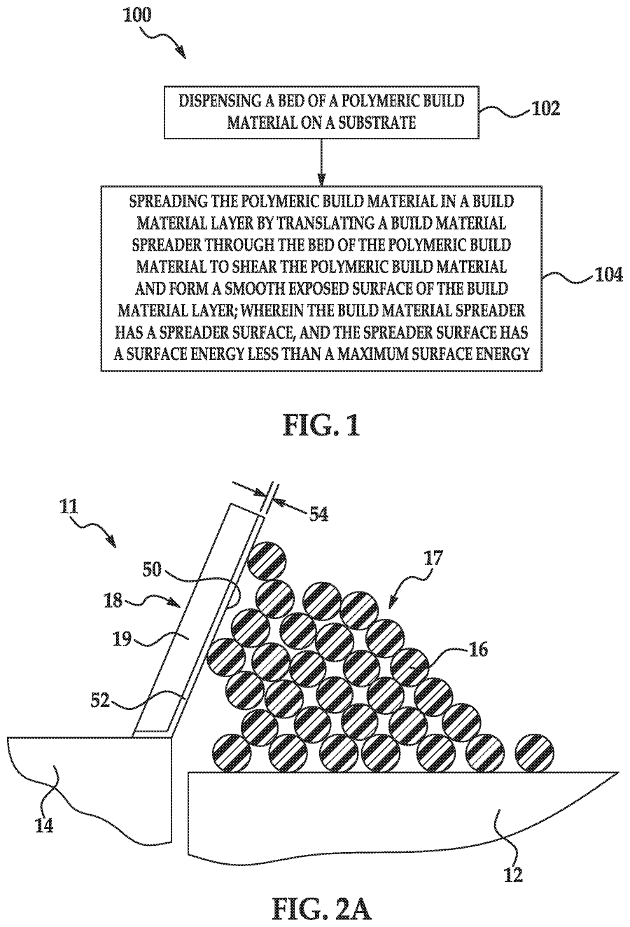

An example of a 3D printing method 100 using examples of the build material spreader 18 and the 3D object printer 11 disclosed herein is shown in FIG. 1. The method 100 includes dispensing a bed 17 of a polymeric build material 16 on a substrate 12 (reference numeral 102); and spreading the polymeric build material 16 in a build material layer 31 by translating a build material spreader 18 through the bed 17 of the polymeric build material 16 to shear the polymeric build material 16 and form a smooth exposed surface 33 of the build material layer 31; wherein the build material spreader 18 has a spreader surface 50, and the spreader surface 50 has a surface energy less than a maximum surface energy (reference numeral 104). This method 100 is also schematically illustrated in FIGS. 2A through 2F.

Some of the examples of the method 100 disclosed herein further include determining the maximum surface energy based on a composition of the build material 16. In some examples, the composition of the build material 16 includes polyamide 12 powder, and the maximum surface energy is a Fowkes Surface Free Energy (SFE) of about 19 dynes per centimeter. In such examples, the maximum surface energy is determined by calculating the surface free energy of the build material spreader 18 using the Fowkes method, using the build material spreader 18 to spread the polyamide 12 build material into the layer 31, patterning and fusing the layer 31 to form a 3D object layer, and then evaluating the defect level of the 3D object layer. In the examples disclosed herein, it has been found that the maximum surface energy for the build material spreader 18 corresponds with a threshold level of defects that are formed in the resulting 3D object layer. For 3D objects based on the composition of the build material including polyamide 12, the spreader surface 50 having an SFE of 19 dynes per centimeter results in minimal or no defects.

In some examples of the method 100 disclosed herein, the spreader surface 50 has a Root Mean Square (RMS) surface roughness less than about 400 microns. In other examples, the spreader surface 50 has an RMS surface roughness less than 550 microns. In some examples of the method 100 disclosed herein, the build material spreader 18 may be composed of a single material, in other examples, the build material spreader 18 may have a surface layer 52 disposed on a spreader base. In some examples of the method 100 disclosed herein, the spreader surface 50 is a surface layer 52 of polyimide tape, masking tape, fiberglass tape, flat acrylic enamel paint, or silicon nitride. In some examples, the spreader surface 50 is a surface layer 52 of a TUFRAM® 615 coating material.

As shown in FIG. 2A, some examples of the 3D printing method 100 of the present disclosure include dispensing a bed 17 of a polymeric build material 16 on a substrate 12. In the example depicted in FIG. 2A, the substrate 12 is a build area platform. A printing system (e.g., the system 10 shown in FIG. 3) may be used to dispense the polymeric build material 16. The printing system 10 may include a substrate 12, a build material supply 14 containing the polymeric material 16, and the build material spreader 18.

The substrate 12 receives the polymeric build material 16 from the build material supply 14. The substrate 12 may be moved in the directions as denoted by the arrow 15 (see FIG. 3), e.g., along the z-axis, so that the polymeric build material 16 may be delivered to the substrate 12 or to a previously formed layer of the 3D object being formed and any non-patterned build material remaining from the previous layer 31. In an example, when the polymeric build material 16 is to be delivered, the substrate 12 may be programmed to advance (e.g., downward) enough so that the build material spreader 18 can push the polymeric build material 16 onto the substrate 12 to form a substantially uniform build material layer 31 of the polymeric build material 16 thereon. The substrate 12 may also be returned to its original position, for example, when a new part is to be built.

The build material supply 14 may be a container, bed, or other surface that is to position the polymeric build material 16 between the build material spreader 18 and the substrate 12. In some examples, the method 100 may further include pre-heating the polymeric build material 16 in the build material supply 14 to a supply temperature that is lower than the melting temperature or the glass transition of the polymeric build material 16. As such, the supply temperature may depend, in part, on the polymeric build material 16 used and/or the 3D printer used. In an example, the supply temperature ranges from about 25° C. to about 150° C. This range is one example, and higher or lower temperatures may be used.

The build material spreader 18 may be moved in the directions as denoted by the arrow 15′ (see FIG. 3), e.g., along the y-axis, over the build material supply 14 and across the substrate 12 to spread the build material 16 and form the build material layer 31 over the substrate 12. The build material spreader 18 may also be returned to a position adjacent to the build material supply 14 following the spreading of the polymeric build material 16. The build material spreader 18 may be a blade (e.g., a doctor blade), a roller, a combination of a roller and a blade, and/or any other device having the spreader surface 50 that is capable of spreading the polymeric build material 16 over the substrate 12. For instance, the build material spreader 18 may be a counter-rotating roller having the surface layer 52 formed thereon. In some examples, the build material supply 14 or a portion of the build material supply 14 may translate along with the build material spreader 18 such that the polymeric build material 16 is delivered continuously to the build material spreader 18 rather than being supplied from a single location at the side of the printing system 10 as depicted in FIGS. 2A and 3.

In FIG. 2A, the build material supply 14 may supply the polymeric build material 16 into a position so that it is ready to be spread onto the substrate 12. The build material spreader 18 may spread the polymeric build material 16 onto the substrate 12. The controller 62 (FIG. 3) may process “control build material supply” data, and in response, control the build material supply 14 to appropriately position the particles of the polymeric build material 16, and may process “control spreader” data, and in response, control the build material spreader 18 to spread the polymeric build material 16 over the substrate 12 to form the layer 31 of polymeric build material 16 thereon. As shown in FIG. 2D, one build material layer 31 has been formed.

Due to the surface energy of the build material spreader 18 disclosed herein, the build material layer 31 has a smooth exposed surface 33.

The build material layer 31 of the polymeric build material 16 has a substantially uniform thickness across the substrate 12. In an example, the build material layer 31 has a thickness ranging from about 50 μm to about 120 μm. In another example, the thickness of the build material layer 31 ranges from about 30 μm to about 300 μm. It is to be understood that thinner or thicker layers may also be used. For example, the thickness of the build material layer 31 may range from about 20 μm to about 500 μm. The layer thickness may be about 2× (i.e., 2 times) the average diameter or size of the polymeric build material particles, at a minimum, for finer part definition. In some examples, the layer thickness may be about 1.2× the average diameter of the polymeric build material particles.

As depicted in FIG. 2D, some examples of the method 100 include, based on a 3D object model, selectively applying a fusing agent 20 on a portion 28 of the polymeric build material 16. The fusing agent 20 may include an energy absorber (e.g., carbon black, an IR absorbing dye, a plasmonic resonance absorber, or another suitable absorber) and an aqueous liquid vehicle (including water and one or more of co-solvents, surfactants and/or dispersants, anti-kogation agent(s), and anti-microbial agent(s)). In the portion 28, the fusing agent 20 is capable of at least partially penetrating into voids between the polymeric build material particles 16, and is also capable of spreading onto the exterior surface of the polymeric build material particles 16. The polymeric build material 16 and the fusing agent 20 may be applied so that a volumetric ratio of a total volume of the polymeric material 16 to a total volume of the applied fusing agent 20 within the portion(s) 28 ranges from about 2:1 to about 200:1. In an example, the volumetric ratio of a total volume of the polymeric material 16 to a total volume of the applied fusing agent 20 within the portion(s) 28 ranges from about 40:1 to about 60:1. It is to be understood that although fusing agent 20 is depicted, for example, in FIG. 2D, a method of 3D printing that does not use a fusing agent 20 is also contemplated and disclosed herein.

Also as depicted in FIG. 2D, some examples of the method 100 further include, selectively applying, based on the 3D object model, a detailing agent 22 on another portion 48 of the polymeric material 16. The detailing agent 22 may include a surfactant, a co-solvent, and a balance of water. In other examples, a detailing agent 22 is not used. In the other portion 48, the detailing agent 22 is capable of at least partially penetrating into voids between the polymeric build material particles 16, and is also capable of spreading onto the exterior surface of the polymeric build material particles 16. The polymeric build material 16 and the detailing agent 22 may be applied so that a volumetric ratio of a total volume of the polymeric material 16 to a total volume of the applied detailing agent 22 within the other portion(s) 48 ranges from about 2:1 to about 200:1.

It is also to be understood that when an agent (e.g., the fusing agent 20 or the detailing agent 22) is to be selectively applied to the polymeric build material 16, the agents 20, 22 may be dispensed from an applicator 24, 24′. The applicator(s) 24, 24′ may each be a thermal inkjet printhead, a piezoelectric printhead, a continuous inkjet printhead, etc. depending upon the agent 20, 22 that is being dispensed, and thus the selective application of the agent(s) 20, 22 may be accomplished by thermal inkjet printing, piezoelectric inkjet printing, continuous inkjet printing, etc. The controller 62 may process data, and in response, control the applicator(s) 24, 24′ (e.g., in the directions indicated by the arrow 15″, see FIG. 3) to deposit the agent(s) 20, 22 onto predetermined portion(s) of the polymeric material 16. It is to be understood that the agents 20, 22 may be applied in a single printing pass, or may be applied in separate printing passes.

It is to be understood that the other portion(s) 48 that receive the detailing agent 22 include polymeric build material 16 that is not to become part of the final 3D object. In some examples, the detailing agent 22 may be applied solely at the edges of the patterned portion 28 and/or wherever notches, holes, etc. are to be formed. Applying the detailing agent 22 adjacent to the edges of the patterned portion 28 helps to define the voxels to be coalesced and hence the part form/shape. In these examples, some of the polymeric build material 16 (e.g., at the outermost edges of the substrate 12) may not be exposed to the detailing agent 22 or the fusing agent 20. Having non-patterned and non-detailed portions may be used when the polymeric build material 16 does not substantially absorb the radiation on its own. In other examples, the detailing agent 22 may be applied to all of the polymeric build material 16 that is not to become coalesced.

After the detailing agent 22 and the fusing agent 20 have been applied to the respective portions 48, 28, examples of the method 100 include exposing the polymeric material 16 to electromagnetic radiation 30. The electromagnetic radiation 30 may be applied by any suitable electromagnetic radiation source 26, such as an infrared radiation source, a microwave radiation source, a visibile light radiation source, or an ultraviolet radiation source. The radiation source 26, (also called energy source 26 herein) used depends, in part, upon the energy absorber that is present in the fusing agent 20.

The fusing agent 20 includes the energy absorber, and thus is responsive to the electromagnetic radiation. The fusing agent 20 may enhance the absorption of the electromagnetic radiation, convert the absorbed radiation to thermal energy, and promote the transfer of the thermal heat to the polymeric build material 16 in contact therewith. In an example, the fusing agent 20 sufficiently elevates the temperature of the polymeric build material 16 in the portion(s) 28 to a temperature above the melting point or the glass transition temperature or within the melting range of the polymeric build material 16, allowing coalescing/fusing (e.g., thermal merging, melting, binding, etc.) of the polymeric build material 16 to take place.

The detailing agent 22 may be non-responsive to the electromagnetic radiation 30. As such, the other portion(s) 48 in contact with the detailing agent 22 are not heated and do not coalesce. The detailing agent 22 can provide an evaporative cooling effect and/or prevent thermal migration from the portion(s) 28 heated as a result of energy absorption by the fusing agent, and thereby prevents coalescence of the other portion 48 of the polymeric material 16.

The application of the electromagnetic radiation forms the object layer 32, shown in FIG. 2E. As shown, the portion 28 of the polymeric build material 16 patterned with the fusing agent 20 and exposed to electromagnetic radiation becomes a coalesced block, while the other portion 48 of the polymeric build material 16 having the detailing agent 22 thereon remains as separable particles.

Once the object layer 32 is formed, additional polymeric build material 16 may be applied on the object layer 32, as shown in FIG. 2F. The additional polymeric build material 16 may be spread using the build material spreader 18 disclosed herein, which shears the build material 16 and forms a smooth exposed surface 33 of the additional build material layer. While not shown, it is to be understood that the processes shown in FIGS. 2B, 2C, 2D and 2E may then be repeated to form an additional object layer. More specifically, the fusing agent 20 may be selectively applied on at least a portion of the additional polymeric build material 16, according to a pattern of a cross-section for the new object layer which is being formed; and the detailing agent 22 may be selectively applied on at least another portion of the additional polymeric build material 16 that is not to become part of the new object layer. After the agents 20, 22 are applied, the entire build material layer of the additional polymeric build material 16 is exposed to electromagnetic radiation in the manner previously described. The application of the polymeric build material 16, the selective application of each of the fusing agent 20 and the detailing agent 22, and the exposure to electromagnetic radiation 30 may be repeated a suitable number of cycles in order to form the final 3D object according to a 3D object model.

In another example of the method 100, the layers of the 3D object are formed via selective laser sintering (SLS) or selective laser melting (SLM). In this example of the method 100, the build material spreader 18 may be used to spread the build material 16 and form the build material layer 31 over the substrate 12. In this example, however, no fusing agent 20 is applied on the build material 16. Rather, an energy beam is used to selectively apply radiation to the portions of the build material 16 that are to coalesce/fuse to become part of the object.

In this example, the source of electromagnetic radiation may be a laser or other tightly focused energy source that may selectively apply radiation to the build material 16. The laser may emit light through optical amplification based on the stimulated emission of radiation. The laser may emit light coherently (i.e., constant phase difference and frequency), which allows the radiation to be emitted in the form of a laser beam that stays narrow over large distances and focuses on a small area. In some examples, the laser or other tightly focused energy source may be a pulse laser (i.e., the optical power appears in pulses). Using a pulse laser allows energy to build between pulses, which enables the beam to have more energy. A single laser or multiple lasers may be used.

3D Printing System

Referring now to FIG. 3, an example of the 3D printing system 10 that may be used to perform examples of the method 100 disclosed herein is depicted. It is to be understood that the 3D printing system 10 may include additional components (some of which are described herein) and that some of the components described herein may be removed and/or modified. Furthermore, components of the 3D printing system 10 depicted in FIG. 3 may not be drawn to scale and thus, the 3D printing system 10 may have a different size and/or configuration other than as shown therein.

In an example, the three-dimensional (3D) printing system 10, comprises: a build material supply 14 of build material particles 16; a build material spreader 18; a supply of a fusing agent 20 and a supply of a detailing agent 22; applicator(s) 24, 24′ for selectively dispensing the agents 20, 22; a controller 62; and a non-transitory computer readable medium having stored thereon computer executable instructions to cause the controller 62 to cause the printing system 10 to perform some or all of the method disclosed herein.

As mentioned above, the substrate 12 (also called a build area platform herein) receives the polymeric build material 16 from the build material supply 14. The substrate 12 may be integrated with the printing system 10 or may be a component that is separately insertable into the printing system 10. For example, the substrate 12 may be a module that is available separately from the printing system 10. The substrate 12 that is shown is one example, and could be replaced with another support member, such as a platen, a fabrication/print bed, a glass plate, or another build surface.

While not shown, it is to be understood that the substrate 12 may also include built-in heater(s) for achieving and maintaining the temperature of the environment in which the 3D printing method is performed.

Also as mentioned above, the build material supply 14 may be a container, bed, or other surface that is to position the polymeric build material 16 between the build material spreader 18 and the substrate 12. In some examples, the build material supply 14 may include a surface upon which the polymeric build material 16 may be supplied, for instance, from a build material source (not shown) located above the build material supply 14. Examples of the build material source may include a hopper, an auger conveyer, or the like. Additionally, or alternatively, the build material supply 14 may include a mechanism (e.g., a delivery piston) to provide, e.g., move, the polymeric material 16 from a storage location to a position to be spread onto the substrate 12 or onto a previously patterned build material layer.

As shown in FIG. 3, the printing system 10 also includes the build material spreader 18 and the applicator(s) 24, 24′.

Each of the previously described physical elements may be operatively connected to the controller 62 of the printing system 10. The controller 62 may process print data that is based on a 3D object model of the 3D object/part to be generated. In response to data processing, the controller 62 may control the operations of the substrate 12, the build material supply 14, the build material spreader 18, and the applicator(s) 24, 24′. As an example, the controller 62 may control actuators (not shown) to control various operations of the 3D printing system 10 components. The controller 62 may be a computing device, a semiconductor-based microprocessor, a central processing unit (CPU), an application specific integrated circuit (ASIC), and/or another hardware device. Although not shown, the controller 62 may be connected to the 3D printing system 10 components via communication lines.

The controller 62 manipulates and transforms data, which may be represented as physical (electronic) quantities within the printer's registers and memories, in order to control the physical elements to create the printed article. As such, the controller 62 is depicted as being in communication with a data store 64. The data store 64 may include data pertaining to a 3D object to be printed by the 3D printing system 10. The data for the selective delivery of the polymeric material 16 and the agents 20, 22 may be derived from a model of the object to be formed. For instance, the data may include the locations on each polymeric build material layer, etc. that the applicator 24, 24′ is to deposit the fusing agent 20 and/or the detailing agent 22. The data store 64 may also include machine readable instructions (stored on a non-transitory computer readable medium) that are to cause the controller 62 to control the amount of polymeric material 16 that is supplied by the build material supply 14, the movement of the build area platform 12, the movement of the build material spreader 18, the movement of the applicators 24, 24′, etc.

As shown in FIG. 3, the printing system 10 also includes the radiation source 26. Examples of the radiation source 26 include any electromagnetic radiation source. As shown in FIG. 3, the radiation source 26 may be a module that is available separately from the printing system 10. In other examples, the radiation source 26 may be integrated with the printing system 10.

The radiation source 26 and/or the heater(s) in the substrate 12 may be operatively connected to a driver, an input/output temperature controller, and temperature sensors, which are collectively shown as heating system components 66. The heating system components 66 may operate together to control the radiation source 26 and/or the heater(s) in the substrate 12. The temperature recipe (e.g., heating exposure rates and times) may be submitted to the input/output temperature controller. During heating, the temperature sensors may sense the temperature of the polymeric build material 16 on the substrate 12, and the temperature measurements may be transmitted to the input/output temperature controller. For example, a thermometer associated with the heated area can provide temperature feedback. The input/output temperature controller may adjust the radiation source 26 and/or the heater(s) in the substrate 12 power set points based on any difference between the recipe and the real-time measurements. These power set points are sent to the drivers, which transmit appropriate voltages to the radiation source 26 and/or the heater(s) in the build area platform 12. This is one example of the heating system components 66, and it is to be understood that other heat control systems may be used. For example, the controller 62 may be configured to control the radiation source 26 and/or the heater(s) in the build area platform 12.

To further illustrate the present disclosure, examples are given herein. It is to be understood that these examples are provided for illustrative purposes and are not to be construed as limiting the scope of the present disclosure.

### Examples

Test specimens with various surface compositions were produced from silicon wafers and spreader plates. The surface compositions used are shown in Table 1. Surface Energy measurements were made via contact angle measurements of each surface composition with a series of water and water/diiodomethane mixtures at room temperature. Coefficient of friction (COF) measurements were made by measuring wall friction of polyamide 12 (PA12) powder with the test specimens via a Jenike shear cell at a variety of consolidation stresses at room temperature. The spreader plate test specimens were used with an existing fusing agent (including carbon black as the energy absorber) and polyamide 12 build material (PA-12) in a large format 3D printer to fabricate test objects. No detailing agent was applied in this example. The test objects were examined for defects and catalogued by as being over or under a defect threshold (under is better than over). As used herein, a defect means an area of the 3D object having visible inhomogeneity of spread uniformity. The defect threshold is defined by visibility of a visible inhomogeneity to an unaided eye. Thus, the rows marked “Under” in Table 1 had no areas of inhomogeneity that were visible to an unaided eye. It is to be understood that term “defect” does not imply that an object is unfit for its intended use. The results are shown below in Table 1. In Table 1, AOF is the Angle of Friction, which is related to the coefficient of friction, μ, by the following equation: tan(AOF)=μ. The surface roughness reported in Table 1 is the surface roughness of the spreader surface 50. (See, e.g., FIG. 2A.)

TABLE 1

| | | Fowkes | Surface | |
|---|---|---|---|---|
| | AOF | Surface | Roughness | Defect |
| Surface Composition | (deg) | Energy | (μm RMS) | Level |
| Al₂O₃ (rough) | 26.7 | 27.1(D) | 974.3 | Over |
| Al₂O₃ (smooth) | 25.9 | 29.4(D) | 174.3 | Over |
| KAPTON ® Tape | 22.2 | 18.7(D) | 169.5 | Under |
| Masking Tape | 24.7 | 17.4(D) | 268.1 | Under |
| Fiberglass Tape | 23.7 | | 245.8 | Under |
| Flat Acrylic Enamel Paint | 24.9 | 18.9(D) | 269.4 | Under |
| Spreader Plate | 32.6 | 26.4(D) | 389.4 | Over |
| MAGNAPLATE HMF ® 83 | 32.9 | 32.8(D) | 709.7 | Over |
| TUFRAM ® H + 83 | 33.8 | 19.1(D) | 406.9 | Over |
| TUFRAM ® 615 | 22 | 9.3(D) | 359.7 | Under |
| TaWSi | 29.8 | 31.4(D) | 211.3 | Over |
| Ta₂O₅ | 35.2 | 24.9(D) | 108.7 | Over |
| SiN | 24.8 | 11.5(D) | 121.8 | Under |

For the PA-12 build material, the spreader plate surface compositions having a SFE of 19 dynes per centimeter or less resulted in parts with no or minimal defects.

It is to be understood that the ranges provided herein include the stated range and any value or sub-range within the stated range, as if such values or sub-ranges were explicitly recited. For example, from about 25° C. to about 150° C. should be interpreted to include not only the explicitly recited limits of from about 25° C. to about 150° C., but also to include individual values, such as about 30° C., 98.5° C., 112° C., 150° C., etc., and sub-ranges, such as from about 25° C. to about 80° C., from about 50° C. to about 145° C., from about 135° C. to about 145° C., etc. Furthermore, the term “about” as used herein in reference to a numerical value or range, allows for a degree of variability in the value or range, for example, within 10%, or, in one aspect within 5%, of a stated value or of a stated limit of a range.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is noted that, as used in this specification and the appended claims, the singular forms “a,” “an,” and “the” include plural referents unless the content clearly dictates otherwise.

While several examples have been described in detail, it is to be understood that the disclosed examples may be modified. Therefore, the foregoing description is to be considered non-limiting.

What is claimed is:

1. A build material spreader for a three-dimensional (3D) object printer, comprising:
a spreader surface to contact a build material and spread the build material in a build material layer by translating the build material spreader through a bed of the build material to shear the build material and form a smooth exposed surface of the build material layer, wherein the spreader surface has a surface energy less than a maximum surface energy.

2. The build material spreader as defined in claim 1, wherein the maximum surface energy is based on a composition of the build material.

3. The build material spreader as defined in claim 2, wherein the composition of the build material includes polyamide 12 powder, and wherein the maximum surface energy is a Fowkes Surface Free Energy (SFE) of about 19 dynes per centimeter.

4. The build material spreader as defined in claim 1, wherein the spreader surface has a Root Mean Square (RMS) surface roughness less than about 400 microns.

5. The build material spreader as defined in claim 1, wherein the spreader surface is a surface layer of polyimide tape, masking tape, fiberglass tape, flat acrylic enamel paint, or silicon nitride.

6. A three-dimensional (3D) object printer, comprising:
a build material spreader having a spreader surface to contact a build material and spread the build material in a build material layer by translating the build material spreader through a bed of the build material to shear the build material and form a smooth exposed surface of the build material layer;
wherein the spreader surface has a surface energy less than or equal to a maximum surface energy.

7. The 3D object printer as defined in claim 6 wherein the maximum surface energy is based on a composition of the build material.

8. The 3D object printer as defined in claim 7 wherein the composition of the build material includes polyamide 12 powder, and wherein the maximum surface energy is a Fowkes Surface Free Energy (SFE) of about 19 dynes per centimeter.

9. The 3D object printer as defined in claim 6 wherein the spreader surface has a Root Mean Square (RMS) surface roughness less than about 400 microns.

10. The 3D object printer as defined in claim 6 wherein the spreader surface is a surface layer of polyimide tape, masking tape, fiberglass tape, flat acrylic enamel paint, or silicon nitride.

11. A three-dimensional (3D) printing method, comprising:
dispensing a bed of a polymeric build material on a substrate; and
spreading the polymeric build material in a build material layer by translating a build material spreader through the bed of the polymeric build material to shear the polymeric build material and form a smooth exposed surface of the build material layer;
wherein the build material spreader has a spreader surface, and the spreader surface has a surface energy less than a maximum surface energy.

12. The method as defined in claim 11, further including:
determining the maximum surface energy based on a composition of the build material.

13. The method as defined claim 12 wherein the composition of the build material includes polyamide 12 powder, and wherein the maximum surface energy is a Fowkes Surface Free Energy (SFE) of about 19 dynes per centimeter.

14. The method as defined of claim 11 wherein the spreader surface has a Root Mean Square (RMS) surface roughness less than about 400 microns.

15. The method as defined in claim 11 wherein the spreader surface is a surface layer of polyimide tape, masking tape, fiberglass tape, flat acrylic enamel paint, or silicon nitride.
